(19) United States
(12) Patent Application Publication
(10) Pub. No.: US 2011/0298887 A1
(43) Pub. Date: Dec. 8, 2011

(54) Apparatus Using an Accelerometer to Capture Photographic Images

(76) Inventor: Chad L. Maglaque, Seattle, WA (US)

(21) Appl. No.: 13/083,574

(22) Filed: Apr. 10, 2011

Related U.S. Application Data
(60) Provisional application No. 61/350,479, filed on Jun. 2, 2010.

(51) Int. Cl. H04N 7/14

(52) U.S. Cl. 348/14.16; 348/E07.078

(57) ABSTRACT

Methods and apparatuses for operating an electronic device based on an accelerometer to capture photographic images with a camera integrated into the display screen are described.

### CROSS REFERENCE TO RELATED APPLICATIONS

This application claims priority from the U.S. Provisional Patent Application Ser. No. 61/350,479 filed Jun. 2, 2010, the disclosure of which is attached in Appendix A hereto and incorporated herein by reference.

### BACKGROUND

The present invention relates generally to an electronic device. More particularly, this invention relates to operating an electronic device using an accelerometer of the electronic device for capturing photographic images with a camera integrated into the display screen of the electronic device.

Many personal computers, cell phones, personal digital assistants, and other electronic devices include built-in video cameras. These cameras enable users to take pictures, capture video, and participate in videoconferences.

One problem with traditional built-in cameras stems from the way that the cameras are mounted to (or within) the electronic device. Because the cameras are attached to a mounting point that is adjacent to the user's video display, the user cannot simultaneously look into the camera and view his or her display. Hence, it is difficult for the user to maintain eye contact during a videoconference with another person, because looking at the other person in the display means looking away from the camera. Users find themselves constantly looking back and forth between the display screen and the camera, which can be distracting and make the conversation seem awkward and unnatural. For the same reason, when attempting to take a self-portrait, a user cannot see what the photo will actually look like because glancing at the display means looking away from the camera. When looking at their display, users see an image of themselves looking away at an angle instead of looking directly into the camera. Thus, users that want a head-on portrait must look away from the display and into the camera, shooting blindly without any visual feedback from the display to guide them.

Some image-capturing mechanisms attempt to solve this problem by integrating the image-capturing mechanism directly into the display screen of the electronic device, for example in U.S. Patent Application 2009/0009628.

While an integrated display camera is a much needed improvement over existing image-capturing mechanisms, also needed is the ability to monitor the orientation of an electronic device to ensure that the integrated display camera captures a user facing the display from the best possible view and is able to maintain this view when the orientation of the electronic device changes. Some image-capturing mechanisms attempt to solve this problem by using an accelerometer in the electronic device, for example in U.S. Pat. No. 7,688,306.

Accelerometers are devices widely used for applications as diverse as vibration monitoring, appliance control, joysticks, industrial process control, space launches, satellite control, and many others. For example, an accelerometer has been used in a vehicle as sensor to detect a variety of operating conditions while the vehicle is moving.

As computers have been getting more popular, an accelerometer has been used in a computer to sense a sudden move, such as a free fall, of a computer. A typical application of an accelerometer in a computer is to protect a read/write head of a hard drive. However, there has been a lack of applications that an accelerometer is used in conjunction with software executable within a computer.

### SUMMARY

Methods and apparatuses for operating an electronic device based on an accelerometer are described. According to one embodiment of the invention, an accelerometer attached to an electronic device detects a movement of the electronic device. In response, a machine executable code is executed to perform a predetermined user configurable operation.

According to one embodiment of the invention, an accelerometer of an electronic device may constantly or periodically monitor the movement of the electronic device. As a result, an orientation of the electronic device prior to the movement and after the movement may be determined based on the movement data provided by the accelerometer attached to the electronic device.

According to another embodiment of the invention, an accelerometer may be used to detect a movement of an electronic device and an orientation of the electronic device may be determined based on the movement data provided by the accelerometer. Thereafter, one or more multimedia interfaces may be activated or deactivated based on the determined orientation after the movement.

According to another embodiment of the invention, an accelerometer may be used to detect a movement of an electronic device and an orientation of the electronic device may be determined based on the movement data provided by the accelerometer. Thereafter, one or more composite images can be generated from the separate images captured by integrated display cameras of an electronic device based on the determined orientation after the movement.

### BRIEF DESCRIPTION OF THE FIGURES

Various embodiments of the present invention are described herein by way of example in conjunction with the following figures, wherein:

FIG. 1 is a block diagram illustrating an exemplary architecture of an electronic device according to one embodiment of the invention.

FIG. 2 is a flow diagram illustrating an exemplary process for operating an electronic device in response to an event generated by an accelerometer, according to one embodiment of the invention.

FIGS. 3A and 3B are diagrams illustrating an exemplary mechanism for activating/deactivating multimedia interfaces of an electronic device using an accelerometer, according to one embodiment of the invention.

FIGS. 3C and 3D are diagrams illustrating optional multimedia interface configurations of an electronic device using an accelerometer, according to some embodiments of the invention.

FIG. 4 is a flow diagram illustrating an exemplary process for reconfiguring multimedia interfaces based on an accelerometer, according to one embodiment of the invention.

FIGS. 5A and 5B are diagrams illustrating an exemplary mechanism for generating composite images from the separate images captured by integrated display cameras of an electronic device using an accelerometer, according to one embodiment of the invention.

FIGS. 5C and 5D are diagrams illustrating optional multimedia interface configurations for generating composite images from the separate images captured by integrated display cameras of an electronic device using an accelerometer, according to some embodiments of the invention.

FIG. 6 is a flow diagram illustrating an exemplary process for generating composite images from the separate images captured by integrated display cameras of an electronic device using an accelerometer, according to one embodiment of the invention.

FIG. 10 is a block diagram illustrating an exemplary electronic device having an accelerometer according to one embodiment of the invention.

FIG. 11 is a block diagram of a digital processing system which may be used with one embodiment of the invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In general, terms used herein should be read to have their ordinary and common meanings as understood by one of ordinary skill in the art in view of the descriptions provided herein.

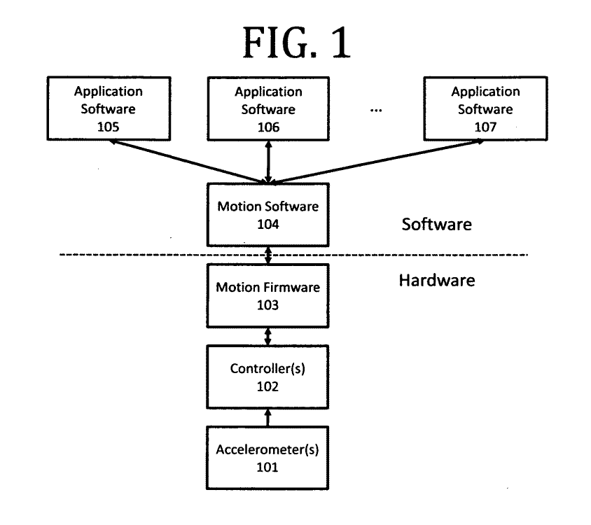

FIG. 1 is a block diagram illustrating an exemplary architecture of an electronic device according to one embodiment of the invention. In one embodiment, the exemplary system 100 includes, but is not limited to, a processor, a memory coupled to the processor, the memory having instructions stored therein, and an accelerometer coupled to the processor and the memory to detect movement of the electronic device, where the processor executes instructions from the memory to perform one or more predetermined user configurable actions in response to the detection of the movement of the electronic device. In an alternative embodiment, the exemplary system 100 further includes a controller coupled to the accelerometer to determine a direction of the movement based on movement data provided by the accelerometer and to compare the determined direction of the movement with a predetermined direction to determine whether the determined direction relatively matches the predetermined direction in order to execute the instructions.

Referring to FIG. 1, according to one embodiment, exemplary system 100 includes one or more accelerometers 101, one or more controllers 102 coupled to the accelerometers 101, a motion related firmware 103, motion software component 104, and one or more application software 105-107. The accelerometer 101 may be attached to the electronic device, such as, for example, a motherboard of the electronic device. Alternatively, the accelerometer 101 may be integrated with another component of the electronic device. For example, the accelerometer 101, may be integrated with a chipset of the electronic device. Further still, the accelerometer 101 may include or be integrated with a gyroscope.

According to one embodiment, the accelerometer 101 is able to detect a movement including an acceleration and/or de-acceleration of the electronic device. The accelerometer 101 may generate movement data for multiple dimensions, which may be used to determine a moving direction of the electronic device. For example, the accelerometer 101 may generate X, Y, and Z axis acceleration information when the accelerometer 101 detects that the electronic device is moved. In one embodiment, the accelerometer 101 may be implemented as those described in U.S. Pat. No. 6,520,013. Alternatively, the accelerometer 101 may be implemented using a variety of accelerometers commercially available. For example, the accelerometer 101 may be a KGF01 accelerometer from Kionix or an ADXL311 accelerometer from Analog Devices.

In addition, the exemplary system 100 includes one or more controllers 102 coupled to the accelerometer(s) 101. The controller 102 may be used to calculate a moving direction, also referred to as moving vector, of the electronic device. The moving vector may be determined according to one or more predetermined formulas based on the movement data (e.g., X, Y, and Z axis moving information) provided by the accelerometer 101. Certain embodiments of calculations of a moving vector will be described in details further below.

According to one embodiment, the controller 102 is responsible for monitoring one or more outputs of the accelerometer 101 and communicating with other components, such as, for example, a chipset (e.g., a memory controller or a north bridge) and/or a microprocessor (e.g., a CPU), of the electronic device. The controller 102 may be implemented using a variety of microcontrollers commercially available. For example, controller 102 may be a PIC 16F818 microcontroller from Microchip. Controller 102 may be integrated with the accelerometer 101. Alternatively, controller 102 may be integrated with other components, such as, for example, a chipset or a microprocessor, of the electronic device.

In one embodiment, the controller 102 may communicate with other components via a bus, such as, for example, an I2C (inter-IC) bus, and an interrupt line. In response to the movement data, the controller 102 generates an interrupt, for example, a hardware interrupt, a software interrupt, or a combination of both, via an interrupt line to other components, such as, firmware 103, to notify them of such a movement. In addition, the controller 102 may further calculate a moving vector based on the movement data provided by the accelerometer 101. Further detailed information concerning the communications between the controller 102 and other components of the electronic device will be described further below.

Referring back to FIG. 1, motion firmware 103 includes one or more pieces of machine executable code, which may be embedded within one or more hardware components, such as, for example, controller 102 or a chipset (e.g., a part of BIOS, also referred to as basic input/output system), of the electronic device. In one embodiment, motion firmware 103 may be stored in a read-only memory (ROM) (e.g., a flash memory) of controller 102. However, the machine executable code of motion firmware 103 may be upgraded by uploading a newer version into the memory, for example, using a flash utility. The firmware 103 may be responsible for detecting any events that are generated in response to the movement detection. According to one embodiment, the firmware 103 provides a primary communications mechanism between controller 102 and other components, such as, for example, an operating system (OS), of the electronic device.

Motion software 104 may be responsible for communicating between the motion firmware 103 and the rest of software components, such as application software components 105-107, as well as the operating system. In one embodiment, the motion software 104 may be implemented as a part of an operating system, such as, for example, a kernel component or a device driver, etc. The operating system may be implemented using a variety of operating systems commercially available. For example, the operating system may be a Mac OS from Apple Computer. Alternatively, the operating system may be a Windows operating system from Microsoft. Other operating systems, such as, for example, a Unix, a Linux, an embedded operating system (e.g., a Palm OS), or a real-time operating system, may also be implemented.

According to one embodiment, in response to the motion detection event, which may be notified by the motion firmware 103, the motion software component 104 may communicate the event to one or more application software 105-107. In response to the detection, the application software 105-107 may perform certain operations. The applications 105-107 may be a variety of different applications, such as, image-capture software, etc. Certain embodiments of the operations performed by the applications 105-107 will be described in details further below.

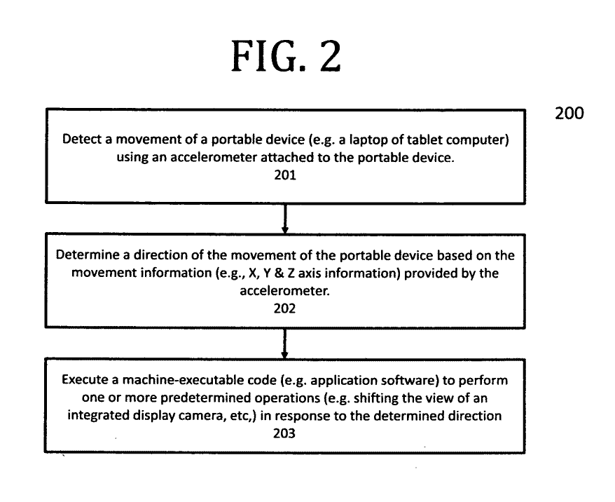

FIG. 2 is a flow diagram illustrating an exemplary process for operating an electronic device in response to an event generated by an accelerometer, according to one embodiment of the invention. Exemplary process 200 may be performed by a processing logic that may comprise hardware (circuitry, dedicated logic, etc.), software (such as is run on a dedicated machine), or a combination of both. In one embodiment, exemplary process 200 includes, but is not limited to, detecting movement of an electronic device using an accelerometer attached to the electronic device, and executing machine-executable code to perform one or more predetermined user configurable actions in response to the detection of the movement of the electronic device.

Referring to FIG. 2, at block 201, a movement of an electronic device, such as, for example, a laptop computer or a tablet computer, is detected using an accelerometer (e.g., accelerometer 101 of FIG. 1) attached to the electronic device. In one embodiment, in response to the detection, the accelerometer may generate movement data for multiple dimensions (e.g., X, Y, and Z axes). In response to the detection, at block 202, a direction of the movement is determined based on the movement data provided by the accelerometer. In one embodiment, the direction of the movement is determined by a controller (e.g., controller 102 of FIG. 1). In response to the determined direction, at block 203, one or more machine executable code (e.g., application software) may be executed to perform one or more predetermined user configurable actions, such as, for example, activating one or more integrated display cameras integrated into the display screen of the electronic device, etc. Other operations may also be performed.

### Reconfiguring Image-Capturing Mechanisms Based on an Accelerometer

According to one embodiment of the invention, an accelerometer of an electronic device may constantly or periodically monitor the movement of the electronic device. As a result, an orientation of the electronic device prior to the movement and after the movement may be determined based on the movement data provided by the accelerometer attached to the electronic device. Thereafter, one or more multimedia interfaces of the electronic device may be activated/deactivated or reconfigured based on the determined orientation after the movement.

In this embodiment, and throughout the application, a computer tablet device is used as an example of an electronic device. But it is not so limited. It will be appreciated that other electronic devices, such as, a laptop computer, a tablet computer, a personal digital assistant (PDA), a personal communicator (e.g., a blackberry from Research In Motion), a cellular phone, or a multimedia player (e.g., an MP3 player), etc., may also be utilized. Further, in this embodiment, and throughout the application, integrated display cameras are used as an example of an image-capturing device. But it is not so limited. It will be appreciated that multimedia interfaces may be disposed on different locations of the electronic device

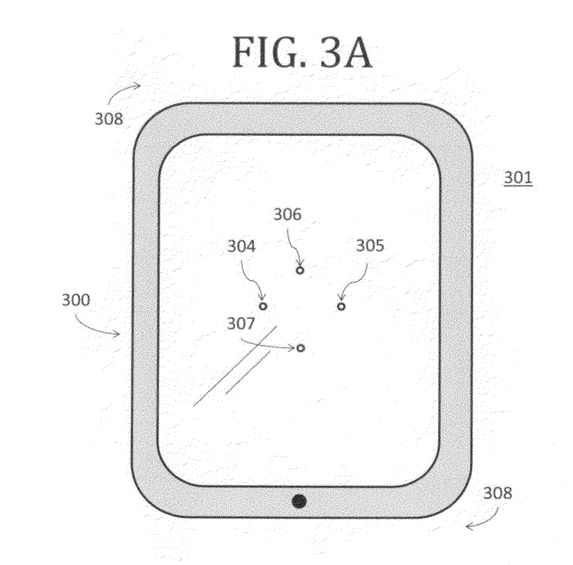

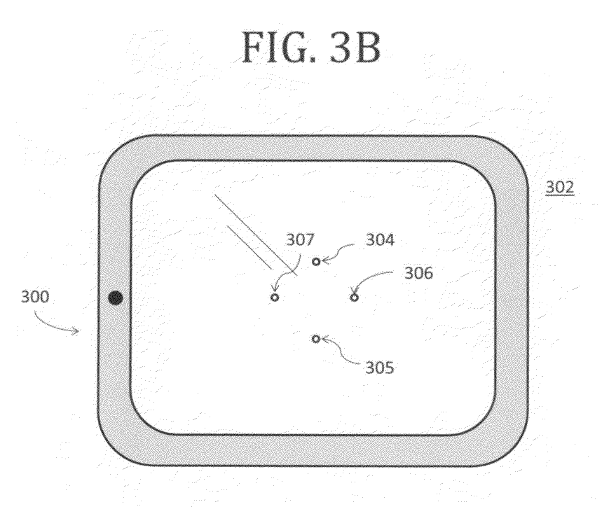

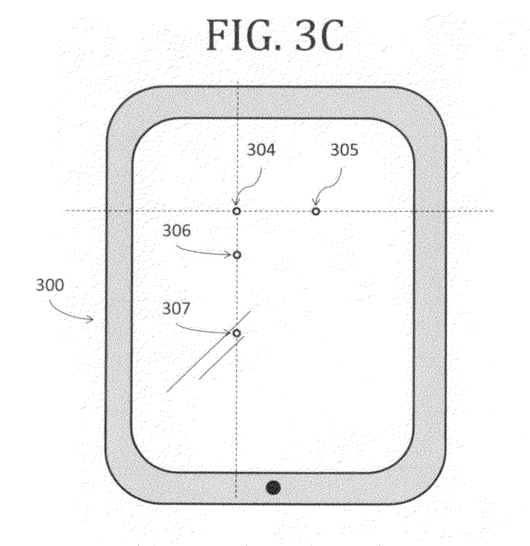

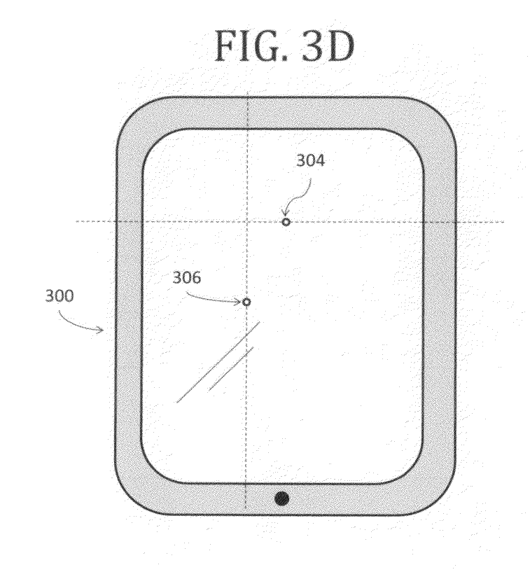

FIGS. 3A and 3B are diagrams illustrating an exemplary mechanism for activating/deactivating multimedia interfaces of an electronic device based on an accelerometer, according to one embodiment of the invention. In this embodiment, as an example, one or more integrated display cameras are used as multimedia interfaces of the portable device. In this embodiment, as shown in configuration 301 of FIG. 3A, multiple integrated display cameras 304-307 are disposed on multiple locations of the electronic device 300. It will be appreciated that other multimedia interfaces and other configurations may also be applied.

Referring to FIG. 3A, according to one embodiment, when a user holds up the electronic device 300 in orientation 301, an accelerometer attached to the electronic device 300 may detect such a movement and orientation 301 is determined by the associated controller and/or firmware coupled to the accelerometer similar to those shown in FIG. 1. In view of the determined orientation, it may be determined that integrated display cameras 304 and 305 are in the best positions to capture images given the orientation 301, while the integrated display cameras 306-307 are not properly oriented. For example, in the orientation 301 prior to a movement, an image capture driver may be configured to capture 3D stereoscopic images, considering integrated display camera 304 on the left and integrated display camera 305 on the right. As a result, integrated display cameras 304-305 may be activated and integrated display cameras 306-307 may be optionally de-activated.

When the electronic device is moved, for example, rotated according to the direction 308 for 90 degrees, the electronic device may end up with different orientation 302 as shown in FIG. 3B. An accelerometer attached to the electronic device may detect such a movement and communicate the movement data to other components of the electronic device as described above. In response to the detection, the integrated display cameras 304-307 may be reevaluated whether the existing configuration is still the best configuration for the orientation after the movement.

After the movement (e.g., turned right 90 degrees), the original integrated display cameras 304-305 that were in the best positions may not be in the best positions any more. Rather, the integrated display cameras 306-307 that were not in the best positions now may be in the best positions. In this example, originally left integrated display camera 304 is now at the top while originally and originally right integrated display camera 305 is on the top as shown in FIG. 3B. As a result, in response to the detection of the movement and the determination of the orientation after the movement, integrated display cameras 306 and 307 may be activated by the image capture driver, since they are, in this example, in the best position to capture stereoscope images. For example, integrated by display camera 307 may be used as a camera on the left, while integrated display cameras 306 may be used as a camera on the right, in order to produce proper visual effects. Similarly, the integrated display cameras 304-305 may be deactivated since they are no longer in the best positions. Other integrated display camera configurations, as illustrated in FIG. 3C and FIG. 3D, may also exist.

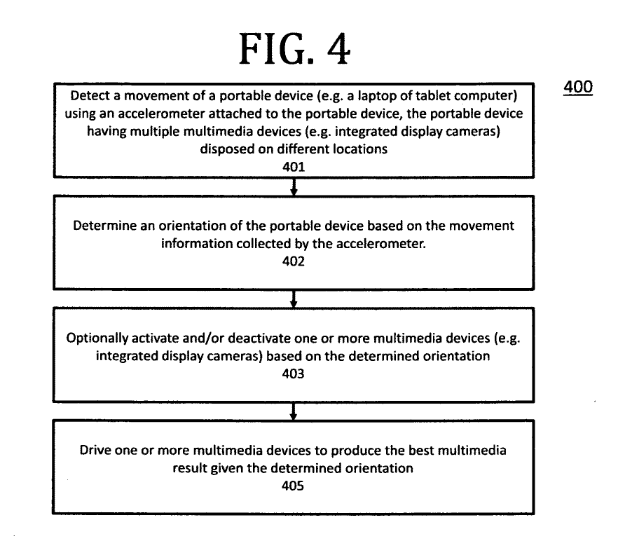

FIG. 4 is a flow diagram illustrating an exemplary process for reconfiguring multimedia interfaces based on an accelerometer, according to one embodiment of the invention. Exemplary process 400 may be performed by a processing logic that may comprise hardware (circuitry, dedicated logic, etc.), software (such as is run on a dedicated machine), or a combination of both. In one embodiment, exemplary process 400 includes, but is not limited to, detecting a movement of an electronic device using an accelerometer attached to the electronic device, determining an orientation of the electronic device after the movement based on movement data provided by the accelerometer, and activating at least one multimedia interface of the electronic device that is best suited given the determined orientation.

Referring to FIG. 4, at block 401, a movement of an electronic device is detected using an accelerometer attached to the electronic device, where the electronic device includes multiple multimedia interfaces or devices disposed on different locations. At block 402, an orientation of the electronic device after the movement is determined based on the movement data provided by the accelerometer. At block 403, one or more multimedia interfaces (e.g. integrated display cameras) may be optionally activated or deactivated based to produce best results given the determined orientation after the movement. At block 404, one or more multimedia devices are driven to produce best results given the determined orientation after the movement. Other operations may also be performed.

### Determining Orientation and Composition Based on an Accelerometer

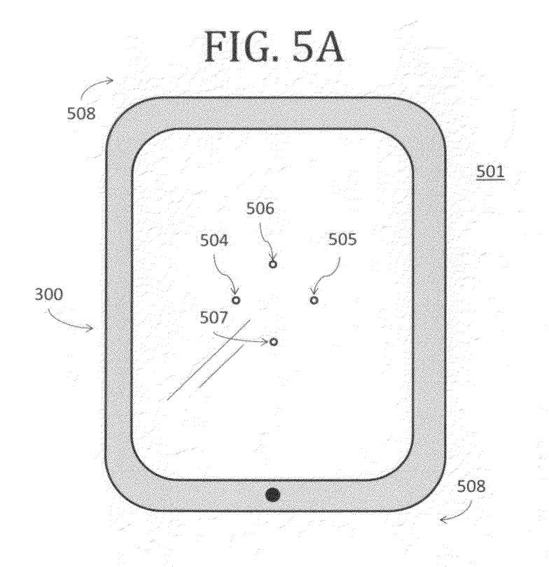

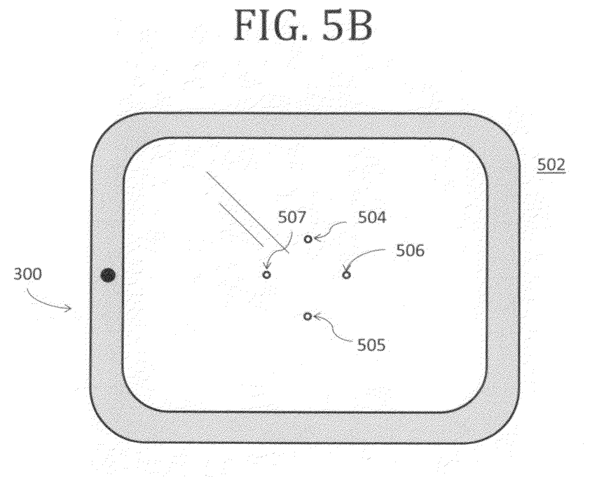

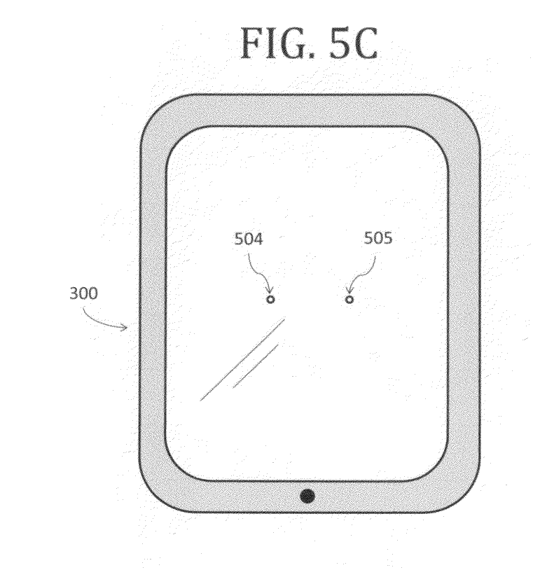

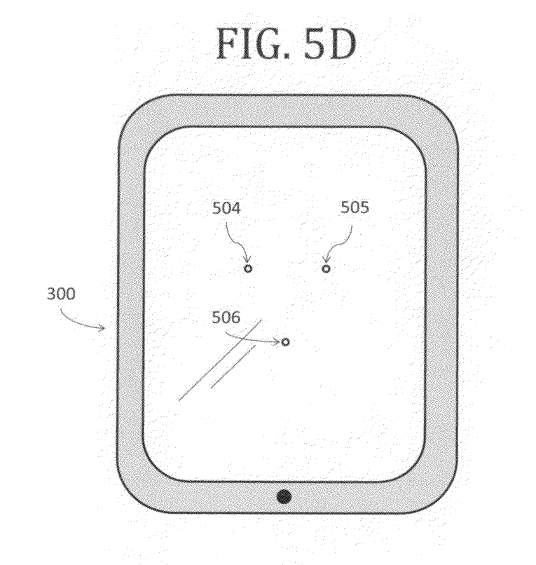

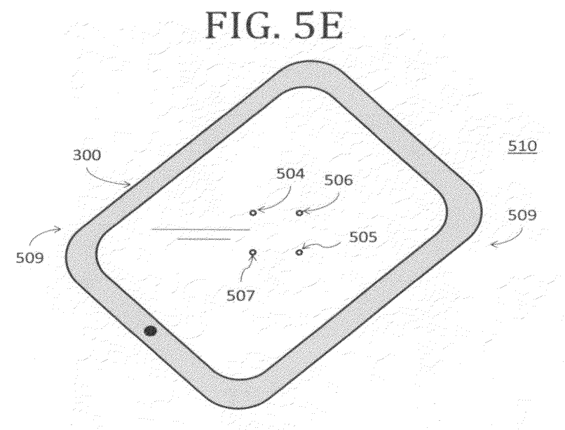

According to one embodiment of the invention, an electronic device includes one or more separate integrated display cameras disposed on different locations of the electronic device. For example, the separate integrated display cameras 504-507 can be coupled to the display screen of the electronic device as illustrated in FIG. 5A. For these embodiments, using the horizontal and vertical components of the separate images captured by the integrated display cameras 504-507 (the horizontal and vertical components being based on orientation data provided by the accelerometer) software or hardware within electronic device 300 can generate either: a single composite photographic image or movie from the separate images captured by the integrated display cameras 504-507; or optionally, stereoscopic photographic images or movies using the separate images captured by integrated display cameras 504-507.

FIGS. 5A and 5B are diagrams illustrating an exemplary mechanism for configuring multimedia interfaces of an electronic device using an accelerometer, according to one embodiment of the invention. In this embodiment, as an example, one or more integrated display cameras of the electronic device are used as multimedia interfaces of the portable device. Referring to FIG. 5A, an electronic device includes multiple integrated display cameras 504-507 disposed on different locations of the electronic device. It will be appreciated that other multimedia interfaces (e.g., microphones) and other configurations may also be applied. In the orientation 501 prior to a movement, images captured by integrated display camera 504-507 may be configured to generate stereoscopic images, as described above, considering images captured by integrated display camera 504 on the left, images captured by integrated display cameras 506-507 in the center and images captured by integrated display camera 505 on the right. When the electronic device is moved, for example, according to the moving direction 508 for 90 degrees, a second orientation 502 is detected and determined by an accelerometer and its associated controller and/or firmware as shown in FIG. 5B.

In response to the detection, the position and orientation of the images captured by integrated display cameras 504-507 may be reevaluated whether the existing configuration is still the best configuration for their orientation after the movement. In this example, originally left images captured by integrated display camera 504 are now at the top while originally center images captured by integrated display cameras 506-507 are on the right and left respectively and originally right images captured by integrated display camera 505 are on the bottom as shown in FIG. 5B. Thus, the existing image capture conditions have changed. As a result, the images captured by integrated display cameras may be configured to produce a visual effect relatively equivalent to the one prior to the movement of the electronic device. For example, images captured integrated by display cameras 507 may be used as images on the left while images captured by integrated display cameras 506 may be used as images on the left and images captured by integrated display cameras 504-505 may be used as center images, in order to produce proper visual effects. Other configurations may also exist, as illustrated in FIG. 5C and FIG. 5D.

When the electronic device is moved, for example, according to the moving direction 509 for 45 degrees, a third orientation 510 is detected and determined by an accelerometer and its associated controller and/or firmware as shown in FIG. 5E. It will be therefore appreciated that for any angle, using the horizontal and vertical components of the separate images captured by the integrated display cameras 504-507 (the horizontal and vertical components being based on orientation determine by the accelerometer, as described herein) software or hardware within electronic device 300 can generate either: a single composite photographic image or movie from the separate images captured by the integrated display cameras 504-507; or optionally, stereoscopic photographic images or movies using the separate images captured by integrated display cameras 504-507.

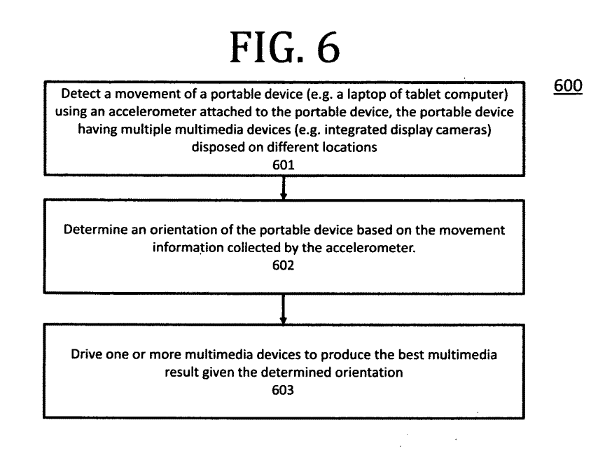

FIG. 6 is a flow diagram illustrating an exemplary process for configuring multimedia interfaces based on an accelerometer, according to one embodiment of the invention. Exemplary process 600 may be performed by a processing logic that may comprise hardware (circuitry, dedicated logic, etc.), software (such as is run on a dedicated machine), or a combination of both. In one embodiment, exemplary process 600 includes, but is not limited to, detecting a movement of an electronic device using an accelerometer attached to the electronic device, determining an orientation of the electronic device after the movement based on movement data provided by the accelerometer, and generating one or more composite images given the determined orientation.

Referring to FIG. 6, at block 601, a movement of an electronic device is detected using an accelerometer attached to the electronic device, where the electronic device includes multiple multimedia interfaces or devices disposed on different locations. At block 402, an orientation of the electronic device after the movement is determined based on the movement data provided by the accelerometer. At block 603, one or more composite images are generated from the separate images captured by one or more image-capturing mechanisms given the determined orientation after the movement. Other operations may also be performed. It will also be appreciated that other multimedia interfaces (e.g., microphones) and other media types (e.g., audio) may also be applied.

### Exemplary Electronic Device Having an Accelerometer

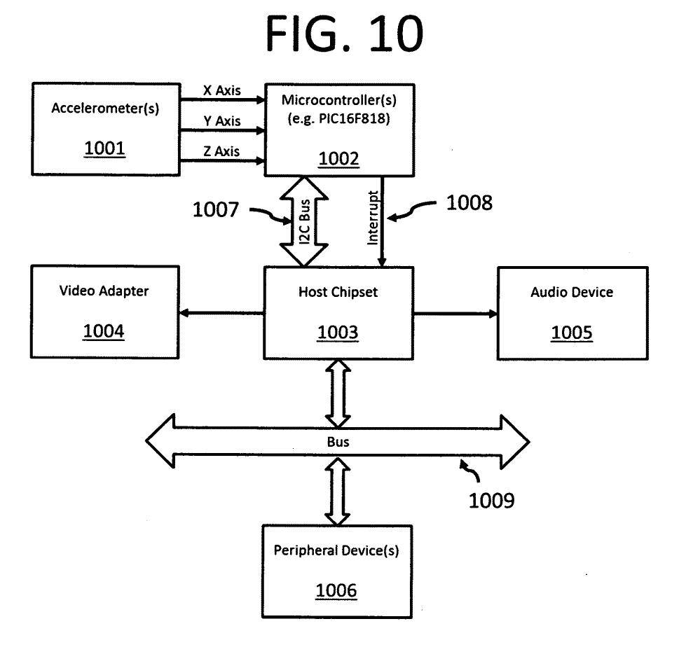

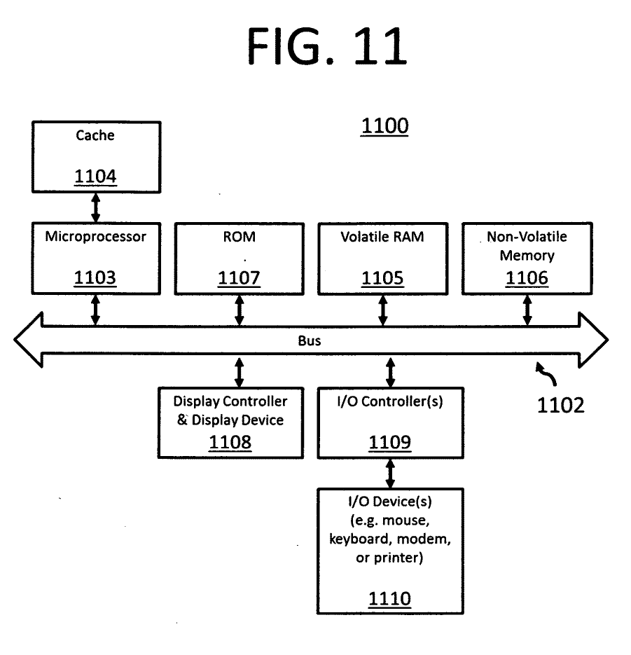

FIG. 10 is a block diagram illustrating an exemplary electronic device having an accelerometer according to one embodiment of the invention. For example, exemplary system 1000 may represent at least a portion (e.g., a subsystem) of the exemplary system 100 shown in FIG. 1 or exemplary system 1100 of FIG. 11. Referring to FIG. 10, exemplary system 1000 includes one or more accelerometers 1001, one or more microcontrollers 1002, a host chipset 1003 that may be coupled to a video adapter 1004 and an audio device 1005, and one or more peripheral devices 1006.

In one embodiment, the accelerometer 1001 is a 3-axis accelerometer, which may provide acceleration data on X, Y, and Z axes. The accelerometer is an electromechanical micro machine encapsulated in a chip package. It presents three analog outputs (e.g., X, Y, and Z axes) whose values are directly proportional to the acceleration being measured along corresponding axes in 3-space. In one embodiment, the accelerometer 1001 may be a KGF01 accelerometer from Kionix or an ADXL311 accelerometer from Analog Devices.

The microcontroller 1002 is responsible for monitoring the analog outputs of the accelerometer 1001 and communicating with the host via the chipset 1003. In one embodiment, the microcontroller 1002 is coupled to the host chipset 1003 via an I2C bus 1007 and an interrupt line 1008. Alternatively, the microcontroller 1002 may be integrated with the host chipset 1003. In one embodiment, the microcontroller 1002 may be a PCI 16F818 microcontroller from Microchip.

According to one embodiment, when the accelerometer 1001 detects that the electronic device is moving, the microcontroller 1002 receives the 3-axis acceleration information from the accelerometer 1001 and notifies the host via the interrupt line 1008. In response, the movement data may be read out from the microcontroller 1002 via the I2C bus 1007. In one embodiment, the microcontroller 1002 may determine a moving direction based on the 3-axis acceleration information received from the accelerometer 1001. Alternatively, the host chipset may perform such operations. In one embodiment, the magnitude of the resultant acceleration vector of all three axes may be determined according to the following formula:

Mag(Accelerationᵣₑₛᵤₗₜₐₙₜ)=Sqrt(X_{accel}²+Y_{accel}²+Z_{accel}²)

In response to the determined magnitude of the acceleration vector, one or more software components (e.g., application software, firmware, and operating system, etc.) executed within the exemplary system 1000 may perform certain operations, for example, those described above throughout the present application. For example, an orientation of a displayed image may be adjusted via the video adapter 1004 and the sound effects may be adjusted via audio device 1005, etc. Furthermore, one or more peripheral devices 1006, such as, for example, integrated display cameras, may be configured accordingly. Other configurations may exist.

### Exemplary Data Processing System

FIG. 11 is a block diagram of a digital processing system which may be used with one embodiment of the invention. For example, the system 1100 shown in FIG. 11 may be used as the exemplary systems shown in FIGS. 1 and 10.

Note, that while FIG. 11 illustrates various components of a computer system, it is not intended to represent any particular architecture or manner of interconnecting the components, as such details are not germane to the present invention. It will also be appreciated that network computers, handheld computers, cell phones, multimedia players, and other data processing systems which have fewer components or perhaps more components may also be used with the present invention. The computer system of FIG. 11 may, for example, be an Apple Macintosh computer or an IBM compatible PC.

As shown in FIG. 11, the computer system 1100, which is a form of a data processing system, includes a bus 1102 which is coupled to a microprocessor 1103 and a ROM 1107, a volatile RAM 1105, and a non-volatile memory 1106. The microprocessor 1103, which may be, for example, a PowerPC G4 or PowerPC G5 microprocessor from Motorola, Inc. or IBM, is coupled to cache memory 1104 as shown in the example of FIG. 11. The bus 1102 interconnects these various components together and also interconnects these components 1103, 1107, 1105, and 1106 to a display controller and display device 1108, as well as to input/output (I/O) devices 1110, which may be mice, keyboards, modems, network interfaces, printers, and other devices which are well-known in the art. Typically, the input/output devices 1110 are coupled to the system through input/output controllers 1109. The volatile RAM 1105 is typically implemented as dynamic RAM (DRAM) which requires power continuously in order to refresh or maintain the data in the memory. The non-volatile memory 1106 is typically a magnetic hard drive, a magnetic optical drive, an optical drive, or a DVD RAM or other type of memory system which maintains data even after power is removed from the system. Typically, the non-volatile memory will also be a random access memory, although this is not required. While FIG. 11 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1102 may include one or more buses connected to each other through various bridges, controllers, and/or adapters, as is well-known in the art. In one embodiment, the I/O controller 1109 includes a USB (Universal Serial Bus) adapter for controlling USB peripherals. Alternatively, I/O controller 1109 may include an IEEE-1394 adapter, also known as FireWire adapter, for controlling FireWire devices. Other components may be included.

Thus, methods and apparatuses for operating an electronic device using an accelerometer have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An electronic device, comprising: a processor; a display; a memory coupled to the processor, the memory having instructions stored therein; and an accelerometer coupled to the processor and the memory to detect movement of the electronic device, wherein the processor executes instructions from the memory to perform one or more predetermined user configurable actions in response to the detection of the movement of the electronic device, including detecting whether the movement of the electronic device is in accordance with a direction associated with the direction of the transition from the viewpoint of the user, and performing a predetermined operation if the movement is not detected in accordance with a direction associated with the direction of the transition.

2. The electronic device of claim 1, further comprising a controller coupled to the accelerometer and the processor to determine a direction of the movement based on movement data provided by the accelerometer, and compare the determined direction of the movement with a predetermined direction to determine whether the determined direction relatively matches the predetermined direction in order to execute the instructions.

3. The electronic device of claim 2, wherein the processor is configured to determine an orientation of the electronic device after the movement based on movement data collected by the accelerometer, wherein the one or more predetermined user configurable actions are performed based on the determined orientation.

4. The electronic device of claim 3, wherein the processor is configured to activate at least one multimedia interface of the electronic device that is best suited given the determined orientation, and optionally deactivate at least one multimedia interface of the electronic device that is less suitable for the given determined orientation.

5. The electronic device of claim 3, wherein the at least one multimedia interface includes two or more integrated cameras.

6. The electronic device of claim 3, wherein the at least one multimedia interface includes two or more integrated microphones.

7. The electronic device of claim 5, wherein the processor is configured to drive at least one integrated camera to have a best visual effect given the determined orientation of the electronic device after the movement.

8. The electronic device of claim 6, wherein the processor is configured to drive at least one integrated microphone to have a best audio effect given the determined orientation of the electronic device after the movement.

9. The electronic device of claim 3, wherein the processor is configured to generate at least one composite photographic image or movie captured by at least one image-capturing mechanism of the electronic device given the determined orientation.

10. The electronic device of claim 3, wherein the processor is configured to generate at least one composite audio recording by at least one audio-capturing mechanism of the electronic device given the determined orientation.

11. The electronic device of claim 3, wherein the processor is configured to determine whether the portable device is held by a user after the movement based on the movement data provided by the accelerometer.

12. The electronic device of claim 1, wherein the electronic device is one of a laptop computer, a tablet computer, a PDA (personal digital assistant), a cellular phone, a personal communicator, and a multimedia player.

13. An apparatus, comprising: means for detecting movement of an electronic device using an accelerometer attached to the electronic device; and means for executing machine-executable code to perform one or more predetermined user configurable actions in response to the detection of the movement of the electronic device, including means for detecting whether the movement of the electronic device is in accordance with a direction associated with the direction of the transition from the viewpoint of the user, and means for performing a predetermined operation if the movement is not detected in accordance with a direction associated with the direction of the transition.

14. The apparatus of claim 13, further comprising: means for determining a direction of the movement based on movement data provided by the accelerometer; and means for comparing the determined direction of the movement with a predetermined direction to determine whether the determined direction relatively matches the predetermined direction in order to execute the machine-executable code.

15. The apparatus of claim 14, further comprising means for determining an orientation of the electronic device after the movement based on movement data collected by the accelerometer, wherein the one or more predetermined user configurable actions are performed based on the determined orientation.

16. The apparatus of claim 15, further comprising means to activate at least one multimedia interface of the electronic device that is best suited for given the determined orientation, and optionally deactivate at least one multimedia interface of the electronic device that is less suitable for the given determined orientation.

17. The apparatus of claim 15, wherein the at least one multimedia interface includes two or more integrated cameras.

18. The apparatus of claim 15, wherein the at least one multimedia interface includes two or more integrated microphones.

19. The apparatus of claim 17, further comprising means to drive at least one integrated camera to have a best visual effect given the determined orientation of the electronic device after the movement.

20. The electronic device of claim 18, further comprising means to drive at least one integrated microphone to have a best audio effect given the determined orientation of the electronic device after the movement.
